(19) United States
(12) Patent Application Publication
(10) Pub. No.: US 2025/0386207 A1
(43) Pub. Date: Dec. 18, 2025

(54) COLLECTION OF CELL DEPLOYMENT INFORMATION

(71) Applicant: Orange, Issy-les-Moulineaux (FR)

(72) Inventors: Charles Hartmann, Chatillon (FR); Antoine Mouquet, Chatillon (FR)

(21) Appl. No.: 18/878,323

(22) PCT Filed: Jun. 22, 2023
(86) PCT No.: PCT/EP2023/067012

§ 371 Date: Dec. 23, 2024

(30) Foreign Application Priority Data
Jun. 27, 2022 (FR) FR2206374

(51) Int. Cl. H04W 16/18; H04W 36/00; H04W 36/08

(52) U.S. Cl. CPC H04W 16/18; H04W 36/0033; H04W 36/08

(57) ABSTRACT

A method for obtaining information by user equipment in a cellular communication network is described. The method includes receiving, from at least one base station of the network, information representative of current deployment conditions of at least one network cell managed by the at least one base station; and transmitting all or some of the received information to at least one application entity in the network.

### PRIOR ART

The invention belongs to the general field of telecommunications.

It relates more particularly to the supply of information allowing certain functionalities implemented by entities of a cellular communications network or connected to a cellular communications network to be improved. The invention has a preferred but non-limiting application in the context of a system or cellular communications network built on a 5G core network (or 5GC network) defined by the 3GPP standard.

It notably allows, in this context, the functionalities implemented by a device for collecting and analyzing data of the network, also denoted by NWDAF (for “NetWork Data Analytics Function”), to be improved.

Modern communications networks, such as 5G networks defined by the 3GPP standard, are confronted by complex situations, which are notably the consequence of a very large number of user equipments (or UEs) to be managed, of the variety of the uses made of the network (and of the demands in terms of latency, of data rate, of resulting volumetry), together with the variety of behaviors of the users of the network over time and in space. In order to handle these complex situations, the operators install within their networks one or more specialized entities responsible for collecting data of the network and for carrying out statistical analyses and predictions (also referred to as “analytics”) based on these data, for example upon the request and the response provided by the network as regards quality of service. These predictions may be global, in other words established at the network level, within a server, an application or else at the regional level. Examples of global predictions are a loading level of the resources of the network, the average quality of service, the number of users connected to the network via their user equipment (or more simply hereinafter UE) or of active sessions. Individual predictions, in other words relating to a user or to a group of users, may also be established, such as for example the future location of the UE of the user or the volumetry of a future communication session of the user established via its UE. By way of illustration, in a 5G core network, the function NWDAF fulfills such a role.

Carrying out predictions by a function NWDAF assumes the prior collection of raw data representative of network facts (e.g. connected status of the UE, cell in which it is located, etc.) from various entities composing the network, also commonly denoted by “network functions” (or NF). These raw data may be global to each function NF, or else may relate to each user. Once established, the predictions allow corrective modifications to be implemented in an anticipated manner on the parameters of the network in order to optimize its operation. The entities using these predictions are typically functions NF, clients of the function NWDAF, which may be distinct or otherwise from the functions NF having collected and supplied the raw data to the function NWDAF, such as for example a function AMF (for “Access and Mobility management Function”), a function SMF (for “Session Management Function”), etc. These client functions NF are accordingly able to adapt their behavior according to the predictions received from the function NWDAF with a view to optimizing the operation of the network and the quality of the service delivered to each user on his/her UE.

The document 3GPP TR 23.791, entitled “Technical Specification Group Services and System Aspects; Study of Enablers for Network Automation for 5G (Release 16)”, v16.2.0, June 2019, discusses various cases of use of such predictions in a 5G network. Thus, for example, the mobility predictions for the UEs may be used by the function AMF in order to optimize the management of the mobility of the UEs, and in particular the determination of their registration area (or RA), this registration area allowing the UE in idle mode to be localized and paging messages to be addressed to them when data destined for them arrive at the network, etc. According to another example, it may prove to be useful for the function SMF to dispose of statistics or of predictions on the network traffic when a function UPF (for “User Plane Function”) is selected allowing the data of the PDU (for “Packet Data Unit”) sessions to be channeled.

It will accordingly be clearly understood, given their importance in the operational functioning of the network, that the statistics and/or the predictions delivered by the function NWDAF must be precise and relevant.

### DESCRIPTION OF THE INVENTION

The invention notably allows an improvement in the precision and the relevance of the statistics and/or predictions delivered by a device for collection and analysis of data from a network such as a network function NWDAF in a 5G network. It may however contribute to improving the functionalities implemented by other application entities of a cellular communications network or connected to a cellular communications network. An “application entity of the network” is understood to mean any type of entity belonging to the network and configured for implementing one or more given processing logics, such as an entity offering and/or consuming services in a network such as a network function or an instance of network function (e.g. functions AMF, SMF, NRF (for “Network Repository Function”), etc.), a base station, etc.

More particularly, the invention relates to a method for obtaining information by a user equipment of a cellular communications network, said method comprising:
a step for receiving information, originating from at least one base station of the network, representative of current deployment conditions of at least one cell of the network managed by said at least one base station; and
a step for transmission to at least one application entity of the network of all or part of said received information.

The invention is also aimed at a user equipment of a cellular communications network comprising:
a receiver module configured for receiving information, originating from at least one base station of the network, representative of current deployment conditions of at least one cell of the network managed by said at least one base station; and
a processing module configured for transmitting to at least one application entity of the network all or part of said received information.

The invention also relates to a method for collection of data by an application entity of a cellular communications network, said collection method comprising a step for receiving information, originating from a user equipment, representative of current deployment conditions of at least one cell of the network managed by said at least one base station of the network.

In a correlated manner, the invention is also aimed at an application entity of a cellular communications network comprising a collection module configured for receiving information, originating from a user equipment, representative of current deployment conditions of at least one cell of the network managed by said at least one base station of the network.

“Information representative of current deployment conditions of a cell” is understood to mean information which corresponds to the real conditions in which the cell is deployed at the moment in time in question. This information may include various types of indications. For example, at least said information representative of deployment conditions relating to:
a disposition of the cell within an architecture of the network (e.g. coverage, radio environment),
a geographical environment of the cell,
a type of deployment of the cell,
a configuration of at least one antenna of the cell,
at least one infrastructure covered by the cell (e.g. road, railroad, building, etc.), and/or
a status of the cell (e.g. loading of the cell, loading within each network slice, number of active users, uplink (UL) or downlink (DL) data rate, congestion indicators, alarm status, status in terms of security, etc.).

The choice to transmit to the user equipment one or the other of these pieces of information may be determined by a configuration of the base station by the operator of the network. As a variant, it may be envisioned for the user equipment to be able to intervene in this choice.

This information on current deployment conditions is dynamic and able to change over time, for example owing to a reconfiguration of the base stations, to the appearance of new infrastructures, to the extinction of some cells (e.g. small cells provided for reasons of capacity during periods when the network is little used such as at night, in order to reduce the energy consumption of the network), etc.

The knowledge of the real deployment of the cells of the network may advantageously be exploited in order to improve the efficiency of the procedures implemented in the network, and incidentally the resulting quality of service. For example, the predictions of mobility of a UE carried out by a network function NWDAF (application entity in the sense of the invention) in a 5G network may be facilitated and made more precise if it is known that the UE is moving along a main highway.

According to another example, the information on congestion of a cell or on average UL and/or DL data rate reached may influence the predictions of quality of service, and incidentally the decisions taken based on these predictions.

Furthermore, the supply of such information to a network function NWDAF allows the artificial intelligence (or AI) models that it uses, where relevant, to be supplied with enriched input data, and thus more precise and more relevant AI models to be constructed for the needs/objectives of the client network functions using the function NWDAF. Typically, by virtue of the enrichment of the input data of the AI models with the information representative of the current conditions of deployment of the cells of the network, it is possible to make new associations appear and/or to eliminate variables with little relevance with respect to outcomes of the processing operations implemented by the client network functions.

The same is true for a base station of the cellular network, which can use the information that a UE uploads to it and has received from another base station in order to decide on the relevance of a handover and the target of this handover.

It goes without saying that these examples of use of the invention are given only by way of illustration.

The information representative of the current conditions of deployment of the cells managed by the base station will therefore enrich the information on certain cells, of which the UE already disposes, like for example static configuration information such as the identity of the cells, the band of frequencies that they use or else the radio access technology or technologies that they support, together with the information linked to the operational functioning of the network such as for example the fact that a cell belongs to a tracking area (or TA), where a TA may comprise one or more cells of the cellular network. It should be noted that the UE also already disposes of information relating to the base station such as the identity of the base station, the list of the TAs (Tracking Areas) and/or of the network slices that it supports. It may be envisioned to complete this information with other information relating to the base station such as for example a status of the station (e.g. loading level or congestion level).

In one particular embodiment, the UE may also transmit, to the application entities of the network which are requesting it, all or part of this static configuration information linked to the operational functioning, together with information relating to the base stations received from the latter in addition to information relating to the current conditions of deployment of the cells.

The invention therefore provides the configuration of all or part of the base stations of a cellular communications network for them to supply, notably to the client UE of the network, information representative of the current conditions of deployment of the cells of the network (such as for example adjacency relationships of the cells). The UE are then configured for transmitting all or part of the information that they have received to other application entities of the network (in other words playing the role of a relay), such as for example application entities of the core network hosting network functions.

Advantageously, the application entities of the network receiving this information may make use of it (or, in turn, transmit it to other interested entities of the network) in order to improve the functionalities that they implement in the network, for example in order to optimize their decision making for devices hosting network functions AMF or SMF, or to improve the predictions that they provide for a device hosting a network function NWDAF. The use of the UEs as relays allows the information to be transmitted to the network to be targeted, according to the needs of the application entities of the network requesting the UEs to obtain this information. The invention thus has a preferred but non-limiting application when the application entities in question belong to the core network and host network functions. However, as previously indicated, it is also applicable to application entities situated within the access network such as for example to other base stations of the cellular network.

The information received from the base stations may also be directly exploited by the UE. The method for obtaining the information may thus, in one particular embodiment, comprise a step for using all or part of said information received for selecting and/or reselecting a cell of the network (for example in order to register with the network or when it is in idle mode, respectively). Thus, the quality of service of the network and the experience of the users are improved in a global manner, by optimizing the decision making not only within the core network and the access network but also within the UEs.

For example, a UE may take the type of deployment of the nearby cells into account in order to choose one of them for connecting to the network: thus, typically, a UE on board a boat may preferably select a cell covering a port or a waterway (or of the “port” or “waterway” type depending on the form given to this information) in order to connect to the network.

The invention furthermore advantageously offers the possibility of relying on signaling interfaces pre-existing within the network (e.g. application programming interfaces (or APIs) or other types of interfaces, standardized or otherwise) for transmitting the information representative of the conditions of deployment of the cells to the UEs, to the network functions of the core network, or else to other base stations. It is not necessary to resort to an additional management layer in order to access this information, which would render the system more complex and would limit the dynamicity of the exchanges of information, for example in the case of modification of the conditions of deployment (e.g. linked to an automatic reconfiguration of a base station and to the modification of the neighborhood information which may result from this).

For example, in one particular embodiment of the method for obtaining information, the information is received by the user equipment in at least one system information block broadcast by said at least one base station on said at least one cell.

In a correlated manner, in a corresponding embodiment of the method for supplying information, the information is sent to said user equipment in at least one system information block broadcast by the base station on said at least one cell.

The use of a system information block broadcast by the base station renders the information representative of the current conditions of deployment of the cells accessible to all the UEs located in the neighborhood of the base station, whether the latter are connected to the network (or simply “connected”) or otherwise (idle mode). This thus offers the possibility to the UEs in idle mode of exploiting this information when they have to select a cell in order to connect to the network. Furthermore, when a UE is connected, it can receive the system information blocks relating to cells other than that which it has selected, and thus use this information for reselecting a cell notably in the case of mobility when it is in idle mode.

Furthermore, this allows the information representative of the current conditions of deployment of the cells to be transmitted simultaneously to a large number of UEs and thus the resources of the network for communicating this information to be saved.

In another embodiment, the information originating from the base station is received by the user equipment, respectively sent by the base station to the user equipment, within a signaling channel dedicated to the user equipment or within at least one system information block transmitted by the base station upon a request from the user equipment.

This allows the information transmitted by the base station to be targeted as a function of the user equipment. For example, depending on its context (e.g. in a mobility situation or otherwise, depending on its location, etc.), some information may not be relevant or may not provide elements of interest to be used by the user equipment or by the application entities to which it is capable of transmitting this information.

Furthermore, the use of a dedicated signaling channel allows a larger quantity of information to be transmitted to the user equipment.

It should be noted that, for the sake of limiting the quantity of signaling exchanged between the base station and the UE, and between the UE and said at least one application entity of the network, and/or of securing the data exchanged, it may be envisioned for all or part of the information representative of the conditions of deployment of the cells to be received or transmitted in a condensed form, for example in the form of hashing values, of keys or else of links allowing the raw information to be accessed in a secure database or from any other internal or external trusted entity or network.

In an alternative or complementary manner, it may also be envisioned for the information on current conditions of deployment of the cells sent to the UE to be selected, for example as previously described, depending on the mobility context of the latter or on other parameters such as the location of the base station and/or of the UE (e.g. rural or urban environment).

Thus, in one embodiment, all or part of the information received by the user equipment depends on a mobility context of the user equipment.

As previously mentioned, the preferred application of the invention is in the context of a 5G network. For example, said at least one application entity to which the user equipment transmits all or part of the information received from the base station may be a device of the network hosting a network function such as an application function (or AF), used to collect data originating from the user equipment (directly or via a device hosting a network exposure function (or NEF)) by a device for collecting and analyzing data of the network such as a device hosting a function NWDAF.

In a correlated manner, in one particular embodiment, the collection method may comprise a step for transmitting to a device for collecting and analyzing data of the network (e.g. device hosting a function NWDAF) all or part of the information received from the user equipment.

This example is however given only by way of illustration, and other devices of the network hosting other network functions may be concerned, for example devices hosting functions AMF or SMF, etc.

The invention may also be used in contexts other than a 5G network. Indeed, some actors in the field of telecommunications anticipate for the 6^{th} generation of mobile networks (also more commonly referred to as 6G) a removal of the borders between access network(s) and core network. In this perspective, the network architectures based on signaling interfaces of the control plane may offer important advantages. The invention may therefore also be readily applied in such a context.

As previously described, various types of information representative of the current conditions of deployment of the cells may be envisioned in the framework of the invention. It should be noted that such information, with the exception of certain information relating to the status of the cell, is currently not known by the base stations: the base station has no knowledge of the real context of deployment of the cells that it manages, and it only disposes of radio parameters that it uses to manage the quality of the radio links, to maintain the communications by means of measurements that it performs and/or which are uploaded by the UEs and/or to broadcast parameters for selection/reselection of cells to the UEs. This type of information is indeed not currently used by the base stations in the processing operations for which they are responsible. With regard to the information relating to the status of the cell, it is not shared with the core network nor with the UEs.

In one particular embodiment, all or part of the information relating to the current conditions of deployment of the cells of the network may be configured within the base stations by the operator of the network (for example in the form of unstructured metadata (e.g. XML, JSON, YAML formats, etc.) in a normalized data reference frame or reference frame specific to the operator of the network) or be acquired or determined by the base stations themselves.

Thus, in one particular embodiment, at least a part of said information has been evaluated by said at least one base station prior to sending it to said user equipment.

For example, it may be envisioned for the base station to evaluate the geographical extent of the coverage area of a cell based on the geographical positions of the UEs served by the latter, where these positions may be supplied by satellite positioning modules (e.g. GPS (for “Global Positioning System”), GNSS (for “Global Navigation Satellite Systems”)) equipping the UEs or deduced by the base station using information of which it disposes on these UEs such as their speed or an observed time difference of arrival (or OTDOA).

As a variant, at least a part of said information has been obtained by the base station originating from a radio planning system adapted to said network prior to sending it to said user equipment.

A radio planning system may typically supply information on the type of deployment envisioned for a cell: in a dense, suburban or rural area, in line of sight (or LOS) or otherwise (or NLOS for “Non Linet Of Sight”), temporary or events-based deployment of the cell, configuration of the cell (e.g. macro, micro or pico cell), configuration of the antennas of the cell (e.g. distributed antenna system (or DAS), etc.). It may also provide information on the infrastructures covered by the cell, for example if the latter is deployed so as to cover a highway, a waterway, a port, a railroad, a station, and potentially identify the infrastructures in question.

In one particular embodiment, the methods for obtaining and for collecting information are implemented by a computer.

The invention is thus also aimed at a computer program on a storage medium, this program being able to be implemented in a computer or, more generally, in a user equipment according to the invention and comprising instructions designed for the implementation of a method for obtaining information such as described hereinabove.

The invention is also aimed at a computer program on a storage medium, this program being able to be implemented in a computer or, more generally, in an application entity of the network according to the invention and comprising instructions designed for the implementation of a collection method such as described hereinabove.

Each of these programs may use any given programing language and take the form of source code, object code, or of code intermediate between source code and object code, such as in a partially compiled form, or in any other desired form.

The invention is also aimed at an information medium or a storage medium readable by a computer and comprising instructions of a computer program such as mentioned hereinabove.

The information or recording medium may be any given entity or device capable of storing the programs. For example, the medium may comprise a storage means, such as a ROM, for example a CD ROM or a microelectronic circuit ROM, or else a magnetic recording means, for example a hard disk, or a flash memory.

On the other hand, the information or recording medium may be a transmissible medium such as an electrical or optical signal, which may be carried via an electrical or optical cable, by a radio link, by a wireless optical link or by other means.

The program according to the invention may, in particular, be down/uploaded over a network of the Internet type.

Alternatively, the information or recording medium may be an integrated circuit in which a program is incorporated, the circuit being designed to execute or to be used in the execution of the methods for obtaining and for collecting information according to the invention.

According to another aspect, the invention relates to a system in a cellular communications network comprising:
at least one base station managing at least one cell of the network and comprising a transmission module configured for sending, to at least one user equipment of the network, information representative of current conditions of deployment of said at least one cell;
at least one user equipment according to the invention receiving said information sent by said at least one base station; and
at least one application entity of the network according to the invention;
in which said user equipment is configured for using and/or for transmitting to said at least one application entity information representative of current conditions of deployment of at least one cell managed by said at least one base station.

It may also be envisioned, in other embodiments, that the methods for obtaining and for collecting information, the user equipment, the application entity and the system according to the invention possess, in combination, all or part of the aforementioned features.

### BRIEF DESCRIPTION OF THE DRAWINGS

Other features and advantages of the present invention will become apparent from the description presented hereinbelow, with reference to the appended drawings which illustrate one exemplary embodiment of it which is totally non-limiting in nature. In the figures:

FIG. 1 shows, in its environment, a system in a network according to the invention, in one particular embodiment;

FIG. 2 shows schematically the hardware architecture of a base station, of a user equipment and of an application entity of the system in FIG. 1;

FIG. 3 shows the functional modules of a base station, of a user equipment and of an application entity of the system in FIG. 1; and

FIG. 4 illustrates the steps of the methods for obtaining, for supplying and for collecting information implemented by the system in FIG. 1 in one particular embodiment.

### DESCRIPTION OF THE INVENTION

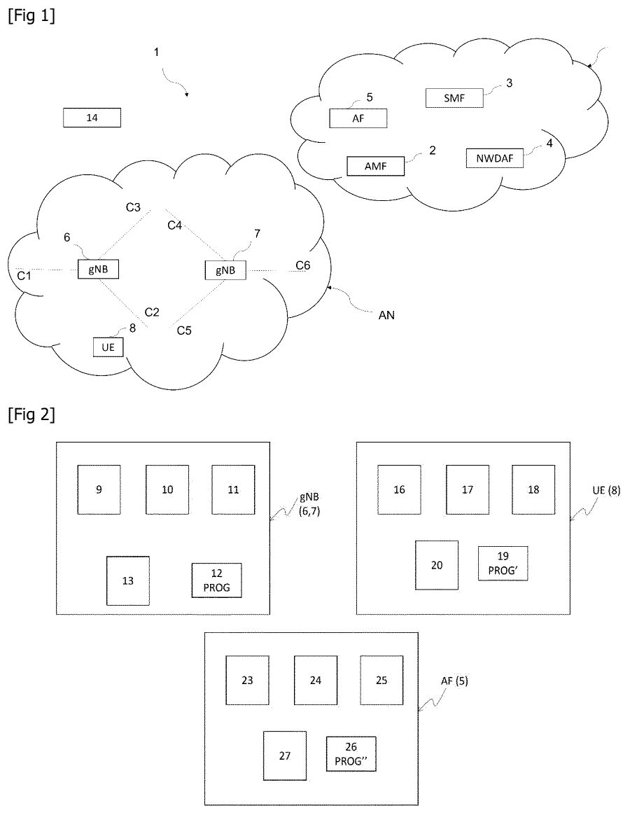

FIG. 1 shows a system 1 in a cellular communications network NW, according to the invention in one particular embodiment. Here, the network NW is a 5G network such as defined by the 3GPP standard, managed by an operator OP; it comprises at least one access network AN and a core network CN.

In a manner known per se, the core network CN relies on a plurality of network functions or NFs offering various services and implementing various functionalities in the core network CN, such as for example a function AMF managing the access to the network and the mobility of the UEs attached to the network, a function SMF managing the sessions established in the network, a function NRF maintaining the profiles of the functions NF of the network, a function NWDAF for collecting and for analyzing data of the network, etc. One or more instances of each of the functions NF of the core network CN may be deployed in order to ensure the operational functioning of the latter. In the example in FIG. 1, the following are notably considered: a device 2 hosting an instance of network function AMF (also denoted for the sake of simplicity by device AMF 2), a device 3 hosting an instance of network function SMF (or SMF device 3), a device 4 hosting an instance of network function NWDAF (or device NWDAF 4) and a device 5 hosting a network function AF (or device AF 5). Of course, this example is given only by way of illustration and is in no way limiting for the invention. These various devices constitute application entities of the network in the sense of the invention.

In order to access the services offered by the network NW, a user equipment or UE connects to the core network CN by means of the access network AN, and more particularly of a base station gNB of this access network. No limitation is attached to the nature of the UE 5: this may be a smartphone, a portable computer, a tablet, a connected object, machine or vehicle, etc.

In a manner known per se, each base station gNB is configured for managing one or more cells of the network NW. The term “cell” is understood here to mean a “unitary” geographical area of the network NW with which a cell identifier (or “NR Cell Identity”), denoting it in a unique manner, and transmission parameters (e.g. a frequence band) are associated. It should be noted that the same transmission parameters may be used simultaneously by several cells of the network duly separated so as to limit any interference. In the example in FIG. 1, two tri-sector base stations gNB 6, 7 are more particularly envisioned: each of these base stations manages three cells of the network (corresponding to the three sectors covered by the base station), namely the cells C1, C2 and C3 for the base station 6, and the cells C4, C5 and C6 for the base station 7. It goes without saying that other configurations may be envisioned.

No limitation is attached to the type of base stations considered for the network AN. Base stations may be envisioned that are fixed and/or mobile (for example carried on board a vehicle, in a drone, in a high altitude platform or, more generally, in any mobile system).

According to the invention, the system 1 comprises:
at least one base station gNB managing at least one cell of the network NW, namely in the example in FIG. 1, the base station 6 managing the cells C1, C2 and C3, and the base station 7 managing the cells C4, C5 and C6;
at least one application entity of the network, such as a network function, or a device hosting such a network function. In the example in FIG. 1, the devices AMF 2, SMF 3, NWDAF 4 and AF 5 are considered as application entities of the network, the device AF 5 being an application entity according to the invention; and
at least one user equipment or UE 8, according to the invention. No limitation is attached to the nature of the UE 8: this may be a smartphone, a portable computer, a tablet, a connected object, etc.

In the embodiment described here, each base station of the system 1 (e.g. gNB 6 and 7) has the hardware architecture of a computer such as shown in FIG. 2. This computer notably comprises a processor 9, a RAM memory 10, a ROM memory 11, a non-volatile memory 12, and means of communication 13 allowing the base station to communicate with UEs (e.g. with the UE 8) and also with other elements of the network NW, such as for example devices of the core network CN or entities external to the network NW, such as a radio planning system 14 adapted to the network NW (for example, that used by the operator OP of the network NW for deploying their network).

Here, the non-volatile memory 12 of the computer is a storage medium readable by the processor 9 and on which a computer program PROG is recorded comprising instructions defining the main steps of a method for supplying information.

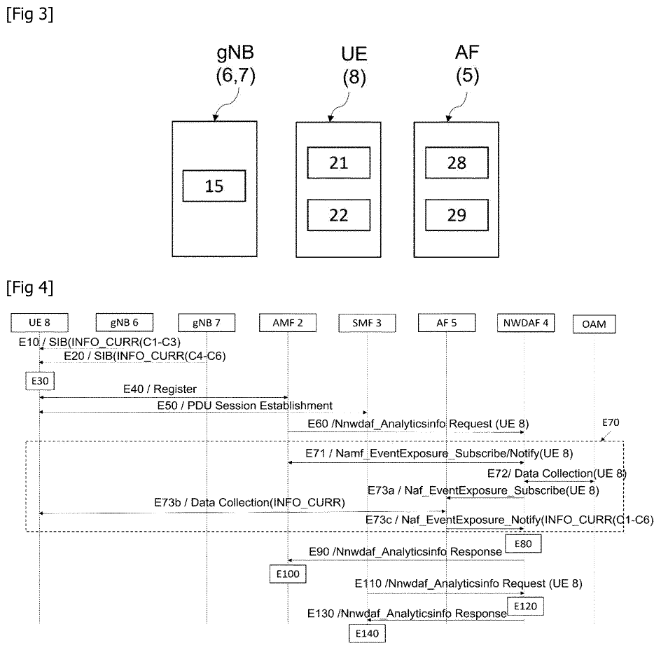

The program PROG defines functional modules of the base station, which are supported by or control the aforementioned hardware elements 9 to 13 of the computer. These functional modules notably include, in the embodiment described here and as illustrated in FIG. 3, a transmission module 15 configured for sending to a user equipment of the network NW, such as the UE 8, information denoted INFO_CURR representative of current conditions of deployment of at least one cell of the network managed by the base station. The operation of the module 15 is described in more detail later on with reference to the steps of the method for supplying information.

Similarly, in the embodiment described here, the user equipment or UE 8 according to the invention has the hardware architecture of a computer as shown in FIG. 2. This computer notably comprises a processor 16, a RAM memory 17, a ROM memory 18, a non-volatile memory 19, and means of communication 20 allowing the UE 8 to communicate, on the one hand, with the base stations of the system 1 (and notably with the base stations 6 and 7) and more generally of the network NW, and on the other hand, with application entities of the network, and notably with devices of the core network CN such as the device AF 5. The means of communication 20 may, for this purpose, rely on standardized interfaces (e.g. on APIs) or otherwise.

The non-volatile memory 19 of the computer here consists of a storage medium according to the invention, readable by the processor 16 and on which a computer program PROG′ according to the invention is recorded, comprising instructions defining the main steps of a method for obtaining information according to the invention.

The program PROG′ defines functional modules of the UE 8 which are supported by or control the aforementioned hardware elements 16 to 20 of the computer. These modules here notably comprise, as illustrated in FIG. 3:
a receiver module 21, configured for receiving information INFO_CURR originating from at least one base station of the system 1, and notably here from the base stations 6 and 7, representative of current conditions of deployment of at least one cell managed by this base station; and
a processing module 22, configured for transmitting, to at least one application entity of the network NW, all or part of said information INFO_CURR received by the receiver module 21. In the embodiment described in more detail here, this application entity is a device of the core network CN hosting a network function, such as the device AF 5. However, as previously mentioned, other application entities may be envisioned, such as for example a base station of the cellular network NW. Furthermore, in the embodiment described here, the processing module 22 is also configured to use all or part of the information INFO_CURR for implementing certain functionalities implemented by the UE 8, and notably for selecting and/or reselecting a cell of the network, for example for registering with the network or when it is in idle mode.

The operation of the modules 21 and 22 is described in more detail later on with reference to the steps of the method for obtaining information according to the invention.

In the embodiment described here, the application entities according to the invention such as the device AF 5 also have the hardware architecture of a computer as shown in FIG. 2. This computer notably comprises a processor 23, a RAM memory 24, a ROM memory 25, a non-volatile memory 26 and means of communication 27 allowing the device AF 5 (and more generally each application entity according to the invention) to communicate, on the one hand, with the UE of the system 1 (and notably with the UE 8), and on the other hand, with devices of the core network CN, such as for example with the device NWDAF 4 (for example via an API).

The non-volatile memory 26 of the computer here consists of a storage medium according to the invention, readable by the processor 23 and on which a computer program PROG″ according to the invention is recorded, comprising instructions defining the main steps of a collection method according to the invention.

The program PROG″ defines functional modules of an application entity according to the invention such as the device AF 5, which are supported by or control the aforementioned hardware elements 23 to 27 of the computer. These functional modules notably comprise, in the embodiment described here, such as illustrated in FIG. 3:
a request module 28, here configured for receiving a request from a device of the core network, such as for example from the device NWDAF 4, for collecting data on a UE such as the UE 8, or on a group of UEs. The request module 28 is furthermore configured for, following this received request, requesting in turn from the UE or the group of UEs in question for it/them to provide it with the requested data. According to the invention, these data include information INFO_CURR representative of current conditions of deployment of at least one cell managed by at least one base station of the system 1 (and hence of the network NW) that the UE has received or is able to receive from the latter. It should be noted that the requests (e.g. from the device NWDAF 4 or from the device AF 5) may be made in the form of simple requests or of subscription to given events, relying for example on mechanisms defined by the 3GPP standard; and
a collection module 29, configured for receiving from the aforementioned UE or group of UEs the information INFO_CURR.

It should be noted that the request module 28 is optional, where the UE or the group of UEs may be configured in another embodiment for spontaneously sending the information INFO_CURR of which they dispose to the device AF 5.

The operation of the modules 28 and 29 is described in more detail later on with reference to the steps of the collection method according to the invention.

With reference to FIG. 4, the main steps of the method for supplying, and methods for obtaining and for collecting information according to the invention are now described when they are respectively implemented, in the embodiment described here, by the base stations 6 and 7, by the UE 8, and by the device AF 5 of the system 1.

It is assumed that the UE 8 is located in the cell C1 of the network NW (managed by the base station 6) and receives from this cell, in a manner known per se, system information SI broadcast within system information blocks (or SIBs) by the neighboring base stations, and more particularly in the example envisioned here, by the base stations gNB 6 and 7 (steps E10 and E20). The acquisition of the system information SI by the UE 8 and the broadcast of this information by the base stations 6 and 7 on the cells that they are managing are here based on the procedures described at paragraph 5.2.2 of the document 3GPP TS 38.331 entitled “Technical Specification Group Radio Access Network; NR; Radio Resource Control (RRC) protocol Specification (Release 17)”, v17.0.0, March 2022. These procedures may be implemented while the UE 8 is in a mode connected to the network or in idle mode.

As described in the document TS 38.331 at paragraph 6.3.1, the system information SI broadcast in the SIB by a base station contains, for each cell managed by the base station, information common to the cell (in other words not specific to a UE of the cell) which a UE needs to access the cell and to operate correctly within the network. It notably comprises, as described at paragraph 4.4 of the document 3GPP TS 38.331, common NAS (for “Non-Access Stratum”) information, data to assist with the localization, parameters for (re) selection of the cell, information on the neighboring cells, information on configuration of the common channels of the cell, etc. According to the invention, the system information SI conventionally broadcast in the context of a 5G network and described in the document 3GPP TS 38.331 is enriched by the transmission module 15 of each base station 6, 7 with information INFO_CURR representative of the current conditions of deployment of the cells managed by said base station 6, 7.

The information INFO_CURR relating to the cells of the network NW reflects the real deployment of the network NW at a given moment in time, in other words, the geographical areas and the infrastructures covered by the cells, the topology of the architecture of the network NW (e.g. adjacence between cells), etc. It is dynamic in the sense that it can change over time depending on the decisions taken by the operator OP of the network NW or autonomously by the base stations (e.g. reconfiguration of certain base stations, etc.), on the appearance of new infrastructures (e.g. roads, buildings, etc.), on the potential movement of the base stations, on the extinction of certain cells (for example in order to limit the energy consumption of the network), etc.

Thus, for example, the information INFO_CURR representative of the current conditions of deployment of a cell managed by a base station (6 or 7 in the example in FIG. 1) may comprise all or part of the following information:
information relating to the disposition of the cell within the architecture of the network, such as the logic or radio environment of the cells (in the form for example of the identity of the cells neighboring said cell);
information relating to the geographical environment of the cell such as the geographical area covered by the cell (expressed for example based on the coordinates (latitude and longitude) of the center of the cell and of its radius, or of a polygonal spatial pattern using the same type of coordinates or via a reference to a coverage map, etc.);
information relating to the type of deployment of the cell, such as an indoor/outdoor deployment, with a direct line-of-sight (LOS) or indirect line-of-sight (NLOS), in a blank signal, dense, suburban or rural zone, having a coverage or capacity objective, in support of a private network, of an infrastructure or of a critical vertical, eventsbased/temporary deployment, configuration of the deployment (e.g. macro/small/pico cell, cell managed by a base station on board a high altitude platform, a drone or a satellite, etc.);
information relating to a configuration of at least one antenna of the cell such as the position and the orientation of this antenna (latitude, longitude, altitude, height on the ground, azimuth, inclination), the deployment of a distributed antenna system (or DAS);
information relating to at least one infrastructure covered by the cell, for example a highway, a railroad, a waterway, one or more buildings, an industrial area, etc. (expressed for example in the form of the identity of the infrastructure in question);
information relating to the status of the cell, such as the loading or the load level (e.g. low, medium, high) of the cell, the loading or the load level of the cell within each network slice, the number of active users in the cell, the uplink (UL) or downlink (DL) data rate, congestion indicators (e.g. level of use of the radio resources, number of packets in the queue), a fault state or alarm level, a status in terms of security (e.g. detection of jamming, detection of attacks of the type “Man In The Middle Attack”, “false base station”, distributed denial of service (or DDOS), compromission by botnets), etc.

This list is not of course exhaustive and other information representative of the current conditions of deployment of the cells may be envisioned in the context of the invention.

The transmission module 15 of the base station may also add to the system information SI information here denoted INFO_gNB concerning it, such as its identity (in the form for example of an identifier “Global RAN Node ID”), the list of the TAs and/or of the slices that it supports, information representative of its status (e.g. loading or load level, number of users using the base station), etc.

It should be noted that the information INFO_CURR and/or INFO_gNB may have been configured within each base station 6, 7 of the system 1 by the operator OP of the network NW (via means known per se and not described here), or may be obtained or discovered dynamically by each base station 6, 7 prior to transmitting it to the UE 8.

For example, a base station 6, 7 may evaluate some of the information INFO_CURR notably itself, such as the geographical area covered by each of the cells that it manages. For this purpose, it may notably use the geographical location of the UEs connected to the cell, where this location may be downloaded by satellite positioning modules (or PNT for “Positioning Navigation and Timing Service”), such as GPS or GNSS modules equipping the UEs, or be calculated by the base station using information on TDOA and on speeds of the UEs which it has available. By virtue of the localization of the UEs and of the knowledge of the cells serving each of these UEs, the base station 6, 7 can establish a “mapping” of the UEs for each cell that it manages and deduce from this the limits of coverage of this cell.

According to another example, particularly well adapted in the case of a mobile base station equipped with a PNT receiver and a compass, a base station 6, 7 may evaluate the position and the orientation of the antennas serving the cells that it manages using the positions downloaded by its PNT receiver and indications supplied by its compass.

According to yet another example, a base station 6, 7 may determine the identity of the neighboring cells of each cell that it manages using the ANR (for “Automatic Neighbor Relation”) functionality of the SON (for “Self-Organizing Networks”) technology designed in a manner known per se to allow the auto-configuration, the auto-exploitation and the auto-optimization of the equipment of a cellular communications network.

According to another example, the base station 6, 7 may deduce information relating to the status of the cell based on its own status: for example, if the base station 6, 7 encounters an overload problem typically caused by the limitation of its processing capacities, this will in turn have an effect on the status of the cells that it manages which will themselves be in an overload state.

Furthermore, the base station 6, 7 disposes, in a manner known per se, of information on the use of the network resources. Using this information, it can detect a state (or a level) of congestion of the cells that it manages. Such a congestion is able to allocate various types of resources used by the cell, such as radio resources or PRB (for “Physical Resource Block”), buffers or else radio channels (e.g. traffic, signaling or paging channels), and intervene when 100% of the resources in question are used (e.g. 100% of the buffers are full). In order to detect such a state, various advance indicators of congestion may be monitored such as for example a percentage of use of the resources which is approaching a critical threshold, an increase in delay times or losses of packets observed on the cell, etc. These indicators may be considered within the information INFO_CURR.

Each base station 6, 7 may furthermore obtain some of the information INFO_CURR of third-party entities, for example of entities of the network NW or of external entities. Notably, it may be envisioned for each base station 6, 7 to be configured for communicating with the radio planning system 14 adapted to the network NW, and to obtain certain information on this radio planning system, such as for example the information relating to the type of deployment of the cells that it manages, the identity of the infrastructures covered by each of these cells, or else the information relating to the configuration of deployment of these cells.

The base station 6, 7 may also have a knowledge of some of the information INFO_CURR and/or INFO_gNB, because it uses this to implement the processing operations for which it is responsible or since it is configured for broadcasting this information over the network NW (for example, the identity of the cells that it manages or the list of the TAs and/or of the slices that it supports).

The nature of the information INFO_CURR (and, where relevant, INFO_gNB) used by each transmission module 15 of a base station 6, 7 to enrich the information system SI may be defined by default within the base station, for example by the operator OP of the network NW, or by a management platform also known as OAM (for “Operations, Administration and Maintenance”) platform. In an alternative or complementary manner, it may be envisioned for the transmission module 15 of a base station to be configured for carrying out a selection of all or part of the information on current conditions of deployment of the cells that it sends in the SIB depending on one or more given factors, such as for example on the location of the base station to which it belongs (e.g. rural or urban environment) or on the mobility of the UEs attached to the cells that the base station manages, etc.

Once the information INFO_CURR (and, where relevant, INFO_gNB) it wishes to or has to broadcast on the cells that it manages has been obtained, the base station 6, 7 transmits it via its transmission module 15 in information system blocks SIB according to the procedure described in the document 3GPP TS 38.331, paragraph 5.2.2 (steps E10 and E20). Thus, the base station 6 broadcasts via its transmission module 15 in the SIB the information INFO_CURR (and, where relevant, INFO_gNB) that it has obtained on the cells C1, C2 and C3, and the base station 7 broadcasts via its transmission module 15 in the SIB the information INFO_CURR (and, where relevant, INFO_gNB) that it has obtained on the cells C4, C5 and C6.

It should be noted that the information INFO_CURR (and, where relevant, INFO_gNB) broadcast by the base station 6, 7 may be transmitted by its transmission module 15 in the SIB in raw form or in a condensed form, for example in the form of hashing values, of keys or of links allowing the raw information to be accessed in a secure database or from any other trusted internal or external or network NW entity (not shown in FIG. 1). Making use of hashing functions notably allows the transmitted information INFO_CURR to be secured: indeed, such hashing functions have various properties and may notably be used, in a known manner, to authenticate and protect the integrity of the data to which they are applied, to manage the confidentiality of this data or to mask it.

It is furthermore noted that, according to the 3GPP standard, the SIB (and all the more so, in the embodiment described here, the information INFO_CURR and, where relevant, INFO_gNB) may be periodically broadcast by the base stations of the network NW (including the base stations 6 and 7 of the system 1) or be transmitted by the base stations upon request from the UEs.

In the example envisioned here, it is assumed that the UE 8, by means of its receiver module 21 and of its means of communication 20, receives the SIB broadcast by the base station 6 containing the information INFO_CURR (and, where relevant, INFO_gNB) relating to the cells C1, C2 and C3, and the SIB broadcast by the base station 7 containing the information INFO_CURR (and, where relevant, INFO_gNB) relating to the cells C4, C5 and C6.

In the embodiment described here, the UE 8 via its processing module 22 uses the information INFO_CURR relating to the current conditions of deployment of the cells C1 to C6 in order to select a cell for registering with the core network CN of the cellular network NW (step E30). For example, for this purpose the processing module 22 may take into account the context of use in which the UE 8 is situated and select, depending on this context, the most appropriate cell from amongst the cells C1 to C6 with regard to the information INFO_CURR of which it disposes. This context may be defined within the UE 8 in a fixed manner (for example configured during the fabrication of the UE or by the user) and may reflect a particular use of the UE 8: for example, the UE 8 is a device designed to equip a boat, an automobile, a train, etc. The context of use of the UE 8 may, as a variant, be determined dynamically by the processing module 22, for example by interrogating the user of the UE 8 via a user interface designed for this purpose, or in an autonomous manner relying for example on the history of the cells that it has used and the type of deployment associated with these cells (for example the N latest cells were of the highway type), and/or potentially on information returned by its accelerometer (which notably allows a pedestrian use to be distinguished from an automobile use, the movements of the UEs not being the same), etc.

Thus, by way of illustration, if the processing module 22 determines that the UE 8 is equipping a boat and that it disposes, within the information INFO_CURR, of information on the conditions of deployment of the cells C1 to C6 and/or on the infrastructures that they cover, the processing module 22 may select a cell from amongst the cells C1 to C6 for which this information indicates a deployment of the port or waterway type or covering a port or a waterway.

According to another example, if the processing module 22 determines that the UE is situated on board a train (respectively, an automobile or a truck) and that it disposes, from amongst the information INFO_CURR, of information on the conditions of deployment of the cells C1 to C6 and/or on the infrastructures that they cover, the processing module 22 may select a cell from amongst the cells C1 to C6 for which this information indicates a deployment of the railroad type or covering a railroad (respectively of the highway type).

Of course, these examples are given only by way of illustration and are not limiting for the invention.

In the example illustrated in FIG. 1, it is assumed that the processing module 22 of the UE 8 selects the cell C1 so as to allow the UE 8 to register with the core network CN and, more precisely, with the device AMF 2. The registration of the UE 8 with the device AMF 2 (step E40) and the establishment of a PDU (for “Packet Data Unit”) session following on via the device SMF 3 (step E50) takes place in a manner similar or identical to what is described in the 3GPP standard and notably in the document 3GPP 23.502 entitled “Technical Specification Group Services and System Aspects; Procedures for the 5G System (5GS); Stage 2; (Release 17)”, v17.4.0, March 2022, at paragraphs 4.2.2.2.2 and 4.3.2.2.1, respectively.

It should be noted that other base stations of the system 1 may be used to transmit information INFO_CURR (and, where relevant, INFO_gNB) to the UE 8 in the course of its movements. For this purpose, they operate in an identical manner to what has previously been described for the steps E10 and E20. Furthermore, in the case of modification of one or more pieces of information INFO_CURR relating to the current conditions of deployment of the cells that it manages, a base station of the system 1 may inform the UE 8 of the modifications carried out. For this purpose, it may communicate these modifications to the UE 8 by means of broadcast SIBs on the cells that it manages, such as previously described for the steps E10 and E20, if the UE 8 is still within the radio range of one of these cells.

It is now assumed that a device of the core network CN hosting a network function, for example the device AMF 2 used by the UE 8, sends a request to the device NWDAF 4 to obtain predictions and/or statistics relating to the UE 8 such as predictions on mobility of the UE 8 (step E60). It should be noted that the invention is not limited to a request coming from the device AMF 2 used by the UE 8: the request for predictions and/or for statistics may indeed originate from another device AMF of the core network CN (in other words hosting another instance of the function AMF) than the device AMF 2 used by the UE 8, or from a device of the core network CN hosting a network function other than a function AMF as described later on. It may furthermore relate to other types of predictions and/or statistics.

In the embodiment described here, in order to request predictions and/or statistics from the device NWDAF 4, the device AMF 2 uses the service Nnwdaf_AnalyticsInfo described in the documents 3GPP TS 23.288 entitled “Architecture Enhancements for 5G system (5GS) to medium network data analytics services (Release 17)”, v17.4.0, March 2022, and TS 28.520 entitled “Technical Specification Group Core Network and Terminals; 5G System; Network Data Analytics Services; Stage 3; (Release 17)”, v17.6.0, March 2022. It should be noted that this request may be made in the form of a simple request (“Nnwdaf_AnalyticsInfo Request” message, as illustrated in FIG. 4) or, as a variant, in the form of a subscription as described in the aforementioned documents.

Upon receipt of the request for predictions and/or for statistics from the device AMF 2, the device NWDAF 4 collects the data INPUT_DATA needed for the calculation of the predictions and/or statistics requested from various entities, such as described in the document TS 23.288 at paragraph 6.7.2.4 (step E70). Thus, according to the procedure described in this document, the device NWDAF 4 may subscribe to the notification of the service data relating to the UE 8 with the device AMF used by the latter (including the device AMF 2), for example in order to be informed of the changes in location of the UE 8 (step E71). It may also send a request to the OAM system for operation, administration and management of the cellular network NW (not shown in the figures) (step E72). It may also collect data from the UE 8 or from another UE. In the embodiment described here, it is assumed that the device NWDAF 4 also collects data from the UE 8 in order notably to obtain all or part of the information INFO_CURR received by the UE 8 from the base stations 6 and 7 (step E73).

For this purpose, the device NWDAF 4 implements the procedure described at paragraph 6.2.8 of the document 3GPP TS 23.288, adapted to the needs of the invention. More particularly, it sends a request to a device hosting an application function AF, capable of collecting such data from the UE 8 (in other words notably authorized by the operator OP to do this and capable of interacting with the UE 8). The device NWDAF 4 discovers which device AF to use by interrogating the network function NRF (which holds the profiles of the functions AF of the network). It is assumed here that the device NWDAF 4 determines that it has to use the device AF 5 to obtain data from the UE 8. It should be noted that, in the embodiment described here based on a cellular 5G network such as defined by the 3GPP standard, the device NWDAF 4 is used to interact with the device AF 5 directly if the device AF 5 is a device considered as reliable (i.e. a trusted device), or via an intermediate device hosting a function NEF otherwise. For the sake of simplicity, it is assumed here that the device AF 5 is reliable and trusted.

The device NWDAF 4 thus sends a request to the device AF 5 (and more specifically its request module 28) for it to collect data from the UE 8 and, in particular, all or part of the information INFO_CURR that the UE 8 has received; for this purpose, here it invokes the service Naf_EventExposure_Subscribe (or the service Nnef_EventExposure_Subscribe if the intervention of a network function NEF is required) such as described in the document 3GPP TS 23.502 (step E73a). This service allows the device NWDAF 4 to subscribe to the notification of any event affecting the UE 8 detected by the device AF 5. In the example envisioned here, the device NWDAF 4 indicates during its subscription request the desire to be notified of the information representative of the current conditions of deployment of the cells of the network NW of which the UE 8 disposes (in other words information INFO_CURR on the cells C1 to C6 managed by the base stations 6 and 7 in the example envisioned here). In order to indicate the events to which the device NWDAF 4 subscribes (information representative of the current conditions of deployment of the cells), it may be envisioned that, when the service Naf_EventExposure_Subscribe is invoked, the device NWDAF 4 uses a new type of event defined for the needs of the invention.

It should be noted that, when the service Naf_EventExposure_Subscribe is invoked, the device NWDAF 4 may indicate the types of information INFO_CURR of interest to it and/or the cells for which it wishes to obtain all or part of the information INFO_CURR. Thus, it may wish to receive the information INFO_CURR held by the UE 8 or, conversely, make a selection from within this information according to one or more selection criteria. Typically, the information INFO_CURR that it wishes to receive may be limited to certain cells of the network NW (e.g. cells C1, C2 and C3 managed by the base station 6), or to the cells managed by a particular base station (e.g. by the base station 6 managing the cell in which the UE 8 is located or used by the UE 8). Similarly, it may target the type of information INFO_CURR that it wishes to receive, for example the information relating to the types of deployment of the cells only. The limitations as regards the desired information INFO_CURR may be determined by the device NWDAF 4 notably based on the information INPUT_DATA that it has collected and/or on the nature of the predictions/statistics which are requested from it.

Following this subscription of the device NWDAF 4, the device AF 5 collects, via its collection module 29, the data corresponding to the events to which the device NWDAF 4 has subscribed (including the information INFO_CURR held by the UE 8 that the base stations 6 and 7 have transmitted to it) (step E73b). The UE 8 transmits to the device AF 5 the data required by the latter via its processing module 22 (step E73b). Upon receiving these data, the device AF 5 notifies this to the device NWDAF 4 according to the subscription of the device NWDAF 4 (step E73c).

It should be noted that, in the embodiment described here, the device NWDAF 4 obtains the information INFO_CURR via the device AF 5 (and potentially a device NEF) using the existing procedure Naf_EventExposure_Subscribe defined in the 3GPP standard (and adapted for the needs of the invention for notifying the information INFO_CURR). This advantageously allows the device NWDAF 4 to be informed, as long as the subscription is valid, of the events to which it has subscribed, and notably of any updates of the information INFO_CURR (for example of the receipt by the UE 8 of new information INFO_CURR relating to new cells). As a variant, the device NWDAF 4 may obtain this information using a simple request addressed to the device AF 5 (or to the device NEF) to trigger the collection of the desired data from the UE 8 (including all or part of the information INFO_CURR held by the UE 8), this request indicating the desired data, or by directly addressing the UE 8 (via a subscription to events or by sending a simple request as mentioned hereinbefore).

Generally speaking, the device NWDAF 4 may address the UE 8 via the device AF 5 directly linked with a request for predictions/statistics which is addressed to it or in an asynchronous manner, for example by anticipating future requests. It may furthermore, for the same request, interrogate the UE 8 several times via the device AF 5.

Furthermore, the information INFO_CURR may be transmitted by the UE 8 to the device AF 5 and/or by the device AF 5 to the device NWDAF 4 in raw form or in a condensed form such as previously described for the transmission of these data by the base stations 6 and 7 to the UE 8.

The device NWDAF 4 subsequently establishes the predictions of mobility of the UE 8 requested by the device AMF 2 using the collected data INPUT_DATA but also all or part of the information INFO_CURR that it has received and which has been collected from the UE 8 by means of the device AF 5 (step E80). The predictions of mobility of the UE 8 carried out by the device NWDAF 4 may for example be influenced by the type of deployment of the cell C1 and notably the fact that it is deployed in support of a given infrastructure such as a freeway: the future positions of the UE 8 situated on this freeway will then have a higher probability. According to another example, if the last X (e.g. X=3) cells used by the UE 8 cover the same highway, the device NWDAF 4 may predict with a fairly high probability that the next cell visited by the UE 8 also covers this highway. Of course, these examples are given only by way of illustration and are not limiting per se.

The device NWDAF 4 transmits the predictions of mobility thus established on the UE 8 to the device AMF 2 (“Nnwdaf_AnalyticsInfo Response” message) (step E90), which in turn uses it for implementing the functionalities for which it is responsible. For example, the device AMF 2 uses the predictions of the device NWDAF 4 in order to establish the registration area (or RA) of the UE 8 in a manner known to those skilled in the art and not described in detail here (step E100). The RA thus established may notably contain all the TA containing the future positions of the UE 8 predicted by the device NWDAF 4. Of course, this example is given only by way of illustration and is not limiting per se.

Similarly, other network functions of the core network CN, such as notably the SMF device 3, may address the device NWDAF 4 in order to obtain predictions and/or statistics relating to the UE 8 (for example predictions on the communications of the UE 8) or relating to other aspects, using as previously described the Nnwdaf_AnalyticsInfo service defined by the 3GPP standard (“Nnwdaf_AnalysticsInfo Request” message) (step E110). The device NWDAF 4 may then use, in order to establish these predictions/statistics requested by the device SMF 3, the data already collected during the step E70 (including the information INFO_CURR) if they are relevant, or again address various entities for collecting new data in a similar or identical manner to what has been previously described during the step E70 for establishing the predictions/statistics requested by the device AMF 2 (especially if the predictions/statistics requested by the device SMF 3 differ from those requested by the device AMF 2) (step E120).

The device NWDAF 4 subsequently transmits the predictions/statistics established to the device SMF 3 (“Nnwdaf_AnalyticsInfo Response” message) (step E130), which can use them to optimize various procedures for managing its session with the UE 8 (step E140). For example, the device SMF 3 may use the predictions to determine in an optimal manner certain parameters of the session such as the network function or functions of the user plane (or UPF for “User Plane Function”) which will channel the data depending on the data rates of the communications predicted by the device NWDAF 4 (e.g. depending on whether the rates are high or if, on the contrary, the transmissions are sporadic). Of course, this example is given only by way of illustration and is not limiting per se.

In the embodiment described here, the UE 8 transmits, via its processing module 22, the information INFO_CURR that it has received from the base stations of the system 1 to devices of the core network CN and notably to network functions in order to allow them to use this information for implementing the functionalities for which they are responsible in the core network CN. In another embodiment, as previously mentioned, the UE 8 may transmit the information INFO_CURR to other application entities of the network and notably to a base station of the access network. The knowledge of the information INFO_CURR may then be used by this base station in order to select in an optimal manner the target cell during a handover (of the UE 8 or of another UE).

Furthermore, in the embodiment described here, the base stations 6 and 7 of the system 1 transmit the information INFO_CURR representative of the real conditions of deployment of the cells that they are managing respectively in SIBs broadcast to said cells. As a variant, it may be envisioned for the information INFO_CURR to be transmitted to a UE (for example to the UE 8) in a dedicated signaling channel. It is then possible for the base stations to adapt (or otherwise) the information INFO_CURR sent to a UE as a function of this UE (for example dependent on its context of mobility, on its location, etc.). As previously described for the SIB, the information INFO_CURR may be transmitted in the dedicated signaling channel in a raw or condensed form.

The invention has just been described with reference to a 5G cellular network defined by the 3GPP standard. This assumption is not limiting per se, and the invention may be applied in other contexts, for example in a 6G cellular network or a proprietary cellular network.

1. A method for obtaining information by a user equipment of a cellular communications network, said method comprising:
receiving information, originating from at least one base station of the network, representative of current conditions of deployment of at least one cell of the network managed by said at least one base station; and
transmitting to at least one application entity of the network all or part of said received information.

2. The method of claim 1, wherein said information is received:
in at least one system information block broadcast by said at least one base station on said at least one cell or transmitted upon request from the user equipment; or
in a signaling channel dedicated to the user equipment.

3. The method of claim 1, further comprising using all or part of said received information for selecting and/or reselecting a cell of the network.

4. The method of claim 1, wherein said application entity is a device hosting an application function requested to collect data originating from said user equipment by a device for collecting and analyzing data of the network.

5. The of claim 1, wherein all or part of the information is received from said at least one base station and/or transmitted to said at least one application entity of the network in a condensed form.

6. The of claim 1, wherein all or part of the information received depends on a mobility context of the user equipment.

7. A method for collecting data by an application entity of a cellular communications network, said collection method comprising receiving information originating from a user equipment representative of current conditions of deployment of at least one cell of the network managed by at least one base station of the network.

8. The method of claim 7, further comprising transmitting to a device for collecting and analyzing data of the network all or part of said information received from the user equipment.

9. The method of claim 8, wherein at least one piece of said information representative of current conditions of deployment of a cell relates to a disposition of the cell within an architecture of the network, to a geographical environment of the cell, to a configuration of at least one antenna of the cell, to a type of deployment of the cell, to at least one infrastructure covered by the cell, and/or to a status of the cell.

10. The method of claim 8, wherein at least one piece of said information representative of current conditions of deployment of a cell has been evaluated by said at least one base station and/or obtained by the base station from a radio planning system adapted to the network.

11. A user equipment of a cellular communications network comprising:
a receiver module configured for receiving information, originating from at least one base station of the network, representative of current conditions of deployment of at least one cell of the network managed by said at least one base station; and
a processing module configured for transmitting to at least one application entity of the network all or part of said received information.

12. An application entity of a cellular communications network comprising a collection module configured for receiving information, originating from a user equipment representative of current conditions of deployment of at least one cell of the network managed by at least one base station of the network.

13. A system of a cellular communications network comprising:
base station managing at least one cell of the network and comprising a transmission module configured for sending to at least one user equipment of the network information representative of current conditions of deployment of said at least one cell;
user equipment of claim 11 receiving said information sent by said base station; and
an application entity of the network comprising a collection module configured for receiving information, originating from the user equipment representative of current conditions of deployment of at least one cell of the network managed by the base station of the network;
in which said user equipment is configured for sending to said application entity of the network the information representative of current conditions of deployment of at least one cell managed by said base station.

14. The method of claim 1, in which at least one piece of said information representative of current conditions of deployment of a cell relates to a disposition of the cell within an architecture of the network, to a geographical environment of the cell, to a configuration of at least one antenna of the cell, to a type of deployment of the cell, to at least one infrastructure covered by the cell, and/or to a status of the cell.

15. The method of claim 1, wherein at least one piece of said information representative of current conditions of deployment of a cell has been evaluated by said at least one base station and/or obtained by the base station from a radio planning system adapted to the network.
